(19) United States
(12) Patent Application Publication
(10) Pub. No.: US 2007/0043736 A1
(43) Pub. Date: Feb. 22, 2007

(54) Smart find

(75) Inventor: Kamal Jain, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/209,142

(22) Filed: Aug. 22, 2005

(51) Int. Cl. G06F 17/30

(52) U.S. Cl. 707/10

(57) ABSTRACT

A domain specific search mechanism having “smart find” functionality of locating a webpage dependent service is provided. In other words, the mechanism facilitates intelligent location of web page dependent links/services via a versatile mechanism that looks-up, deciphers, and/or interprets search criteria. Once an intended target is identified, a mechanism can be employed to locate an appropriate link or group of links resident on a web page. The domain specific search mechanism can employ a local (or remote) dictionary and/or lookup table to associate a search input to a domain specific link/service. Additionally, the described “smart find” mechanism(s) can employ embedded metadata to effect the association of a search input to a domain specific link or group of link(s).

### BACKGROUND

As the Web continues to grow and evolve, searching mechanisms continue to have an ever-increasing important role in manipulating and locating useful and desired information. Searching mechanisms can include search engines, search bars, “control+f” find operations and the like.

A “search engine” can be defined as software that can facilitates data searches based upon a predefined criteria. Search engines can differ in the manner that the mechanisms find and index the material on the Web. As well, search engines can differ in the manner in which they search the indexes based upon a user query.

Conventionally, search engines have been employed to search for websites, web pages, documents or the like that contain a specific keyword or group of keywords. A user can employ a search engine to virtually search for any topic on the Web. By way of example, entering a search criterion such as “Seattle Restaurants” would return a number of Web links to websites and/or web pages ranging from restaurant names, to restaurant locations, to restaurant ratings.

Alternatively, some web pages may include domain specific links that represent partners of the hosting site and/or sites of particular interest. As such, these domain specific links can traditionally be searched based upon the displayed title of the page. More particularly, in one example, a user can employ the “find” functionality (e.g., “control+f”) to search the names of links displayed on the site. However, these conventional searching mechanisms do not search behind-the-scenes. In other words, today, a user is only able to search a web page and/or website for domain specific links that have a particular word or keyword displayed.

Oftentimes web pages are highly cluttered. For example, many links can be associated to and resident on a particular web page. These domain (e.g., web page) dependent links can be associated to services sponsored by the page owner as well as by partners of the page owner. In these situations, if a user desires to locate a service represented by a link, the user must know a keyword included within the name of the link.

In other words, if a user desires to find some service on a webpage it can take quite a while to find the link to it without knowing the particular name or keyword. By way of example, if one wants to find a link to a driving directions site, one has to know that “driving directions” is called “Maps and Direction” and is classified into a specific section within the page. Other situations exist where a brand name (e.g., “Encarta”) is used to tag a specific service (e.g., encyclopedia). This situation can often be more troublesome if the user is looking for an “Encyclopedia” but is unaware that a brand name encyclopedia is listed under the specific brand name (e.g., “Encarta”). In this situation, the user cannot search the links using logical keywords such as “encyclopedia.” Rather, the user would have to specifically search for “Encarta.”

In the aforementioned situations, if one uses the standard “find” functionality of the browser (e.g., “control+f”), looking for “driving directions” or “encyclopedia” does not yield any results.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention disclosed and claimed herein, in one aspect thereof, comprises a domain specific search mechanism having “smart find” functionality of locating a web page dependent service. In other words, the subject invention, in aspects thereof, facilitates intelligently locating web page dependent services via a versatile mechanism that looks-up, deciphers, and/or interprets search criteria. Once an intended target is identified, a mechanism can be employed to locate an appropriate link or group of links resident on a web page.

In another aspect, a domain specific search mechanism can employ a local dictionary and/or lookup table to associate a search input to a domain specific link/service. Other aspects employ remote data sources to effect association (e.g., mapping) of a search input to appropriate domain specific links. Still other aspects can employ link embedded metadata to effect the association of a search input to a domain specific link or group of link(s).

Yet another aspect can employ an interpretation component that can analyze the input to determine an appropriate domain specific link based upon a term or identifier included within a search input. Other aspects can employ a translation component that facilitates the association. Yet other aspects employ natural language analysis to effect association.

Still another aspect can provide for a rules-based logic mechanism of selecting domain specific links based upon a search request. An artificial intelligence component can be provided that employs a probabilistic and/or statistical-based analysis to prognose or infer an action that a user desires to be automatically performed.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a system that facilitates providing domain specific searching in accordance with an aspect of the invention.

FIG. 2 illustrates an exemplary flow chart of procedures that facilitate locating a domain specific link/service based at least in part upon a search input in accordance with an aspect of the invention.

FIG. 3 illustrates a block diagram of a “smart find” system that employs a data store to associate a search input to one or more domain specific links in accordance with an aspect of the invention.

FIG. 4 illustrates a portable device that employs an interpretation component that includes an analyzer component and a translation component in accordance with an aspect of the invention.

FIG. 5 illustrates an exemplary web page domain having multiple domain specific links in accordance with an aspect of the invention.

FIG. 6 illustrates an exemplary web page domain having multiple domain specific service links and iconic representations of services in accordance with an aspect of the invention.

FIG. 7 illustrates an architecture of a “smart find” system that includes a rules-based logic component that can automate functionality in accordance with an aspect of the invention.

FIG. 8 illustrates an architecture of a domain specific search/find system that includes an artificial intelligence component that can automate functionality in accordance with an aspect of the invention.

FIG. 9 illustrates a block diagram of a computer operable to execute the disclosed architecture.

FIG. 10 illustrates a schematic block diagram of an exemplary computing environment in accordance with the subject invention.

### DETAILED DESCRIPTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

One novel aspect of the subject invention is the “smart find” functionality of locating a webpage dependent service. In other words, the subject invention, in aspects thereof, facilitates intelligently locating web page dependent services via a versatile mechanism that looks-up, deciphers, and/or interprets search criteria. Once an intended target is identified, a mechanism can be employed to locate an appropriate link or group of links resident on a web page.

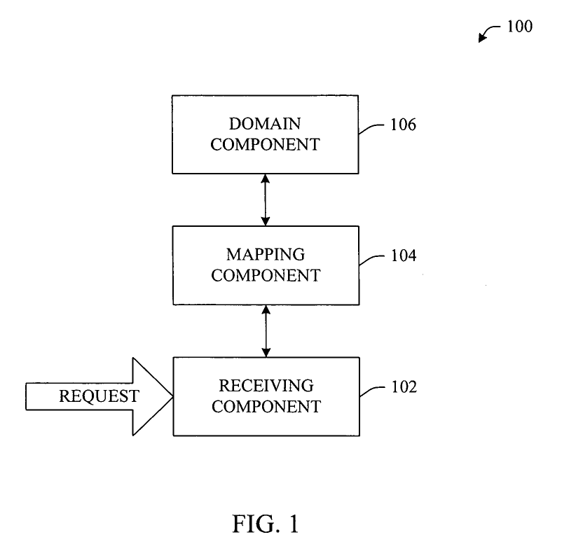

Referring initially to FIG. 1, a system 100 that facilitates a “smart find” is shown. In general, system 100 can include a receiving component 102, a mapping component 104 and a domain component 106. As illustrated, the receiving component 102 can accept an input (e.g., search request). The search request can include any alphanumeric string including letters, numbers, punctuation and/or combinations thereof.

Once received, the receiving component 102 can communicate with the mapping component 104 thereby identifying a domain specific service associated with domain component 106. As well, the mapping component 104 can be employed to identify a domain specific link within domain component 106 which facilitates access to a domain specific or remote service component (not shown).

Aspects of the system 100 can employ a local look-up table, dictionary, link specific metadata, artificial intelligence (AI) or the like to effect intelligently associating a search request to a domain specific link and/or service. These aspects of the system 100 will be better understood upon a review of the figures that follow.

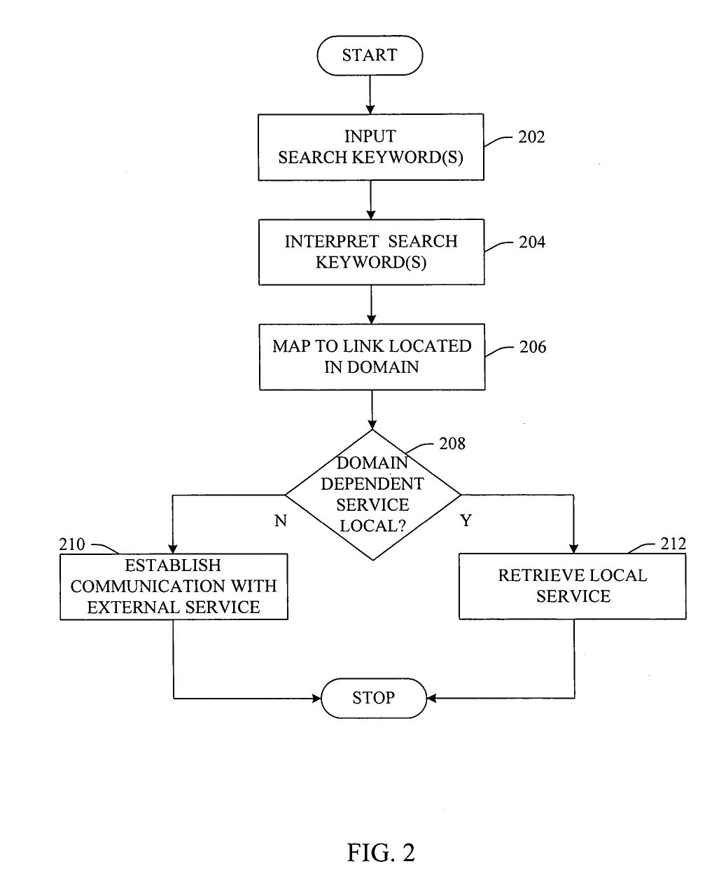

FIG. 2 illustrates a methodology of processing a domain specific “smart” find in accordance with an aspect of the invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

At 202, an input is generated which initiates a process of a domain dependent find operation. In one example, as illustrated, the search criteria can be represented by a keyword or group of keywords. Additionally, in other aspects, the search criteria can be represented by any alphanumeric string, or a string that includes any combination of alpha, numeric and/or punctuation characters.

The input string is interpreted at 204. In one aspect a dictionary can be employed to compare the input string entries in the dictionary. It will be appreciated that, in one aspect, because the domain specific links/services are oftentimes represented by a smaller finite number of links/services, it will be understood that a dictionary can be employed to associate a domain specific link/service to multiple possible inputs. Once the input is interpreted, the input can be mapped to a domain specific link at 206. Although the example of FIG. 2 illustrates a methodology of mapping a search input to a domain specific link, it will be appreciated that other aspects can employ the novel aspects and functionality of the invention to map an input search criteria directly to a domain specific service. These alternative aspects are to be included within the scope of this disclosure and claims appended hereto.

At 208, a determination is made if the link is associated to a local service. If the link is not associated with a local service, at 210, a communication to the external (e.g., remote) service is established. On the other hand, if at 208 it is determined that the identified link is associated with a local service, the local service is retrieved at 212.

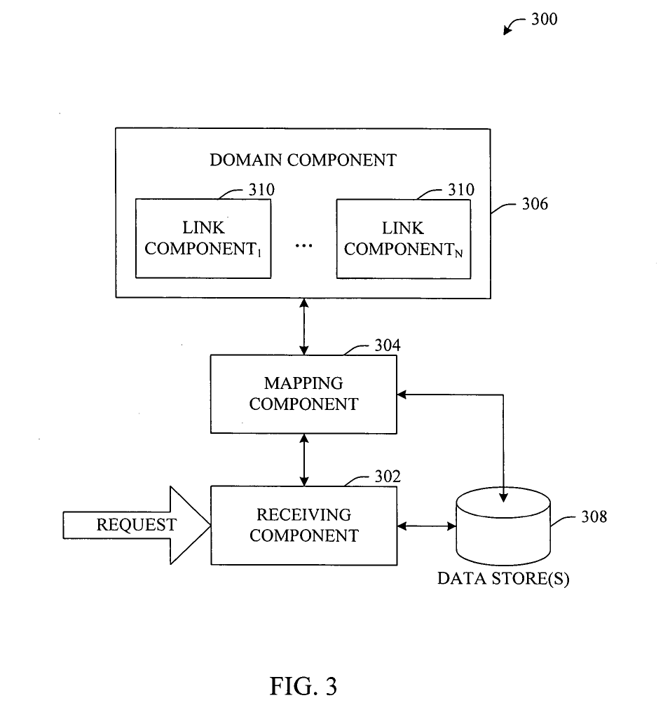

FIG. 3 illustrates an alternative architectural block diagram of a system 300 in accordance with an aspect of the smart find mechanism(s). Generally, system 300 can include a receiving component 302, a mapping component 304 and a domain component 306. Additionally, system 300 can include a data store(s) component 308. It is to be understood that, although the components illustrated in FIG. 3 are depicted as separate components, other aspects can exist that combine components and functionality thereof into common components. These additional aspects are to be included within the scope and this disclosure and claims appended hereto.

As shown, domain component 306 can include 1 to N link components, where N is an integer. It is to be understood that 1 to N link components can be referred to individually or collectively as link components 310. As described supra, it is to be understood that link components 310 can be employed to access local and/or remote services via domain component 306.

Mapping component 304 can employ data store component 308 in order to effect looking-up, deciphering, and/or interpreting the request (e.g., search criteria). In other words, data store component 308 can include a dictionary and/or lookup table that facilitates cross referencing the input (e.g., search criteria) to a descriptive or appropriate word that identifies a domain specific link. In an addition aspect, the dictionary can facilitate associating the input string criteria to an on-screen descriptive keyword(s) thus a search can be performed to locate an appropriate link. It is to be appreciated that standard algorithmic mechanisms can be employed to interpret, decipher, correct and/or map the input string to an appropriate keyword(s) or identifier that facilitates mapping.

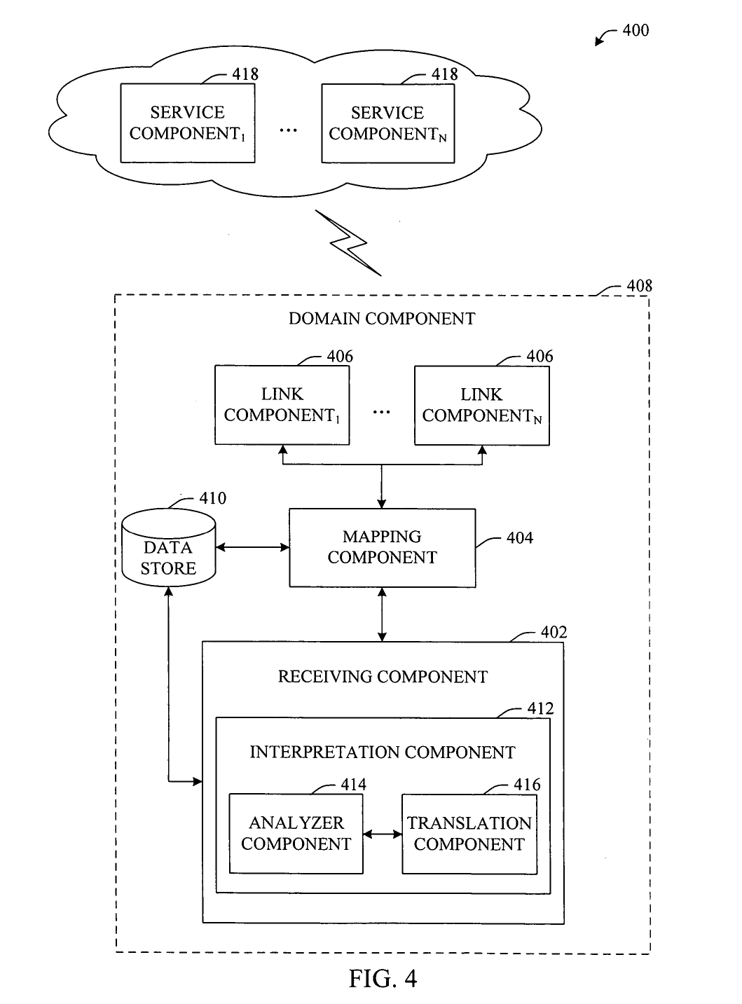

Referring now to FIG. 4, a system 400 that facilitates matching a search request to a domain specific link is shown. As illustrated in FIG. 4, system 400 generally includes a receiving component 402, a mapping component 404 and 1 to N link components, where N is an integer. It is to be understood that 1 to N link components can be referred to individually or collectively as link components 406.

Although FIG. 1 and FIG. 3 illustrate a receiving component and a mapping component external to the domain component, FIG. 4 illustrates yet another aspect whereas the receiving component 402 and the mapping component 404 are included within the domain component 408. It is to be appreciated that these components (402, 404) can be hard-coded into the web page (e.g., domain 408) itself. It is to be understood that alternate aspects exist where all or a subset of these components are located remote from the domain component 408.

In operation, an input or search request can be received by the receiving component 402. The receiving component 402 can employ the data store 410 in conjunction with an interpretation component 412 to determine a desired target domain specific link component 406. It is to be understood that the interpretation component 412 can include an analyzer component 414 and/or a translation component 416. Those skilled in the art will understand that these can components 414 and 416 can employ algorithms to perform appropriate operations to determine a desired and/or available domain specific link/service. By way of example, the analyzer component 414 and the translation component 416 can be employed to perform operations including, but not limited to, interpretation, analysis, correction, translation, association or the like.

Moreover, it is to be understood and appreciated that data store 410 can be any memory/storage device capable of retaining data. For example, in various aspects, data store 410 can be a hard disk drive, a magnetic floppy disk drive, (e.g., to read from or write to a removable diskette), an optical disk drive, (e.g., reading a CD-ROM disk or to read from or write to other high capacity optical media such as the DVD), magnetic storage device, random access memory (RAM), read only memory (ROM), flash memory, or any other medium which can be used to retain the desired information and which can be accessed by a computer.

Once the receiving component 402 processes the input, the mapping component 404 can associate the interpreted input to a domain specific link component 406 or group of domain specific link components 406. As described supra, the mapping component 404 can employ a memory/storage device (e.g., data store 410) to effect the association between the input and the appropriate, or group of appropriate, domain specific link(s). Once an association is established, an associated target service component 418 can be accessed. Although, FIG. 4 illustrates external service components 418, it is to be appreciated that all or a subset of service components 418 can be located within or exclusively associated to the domain component 408.

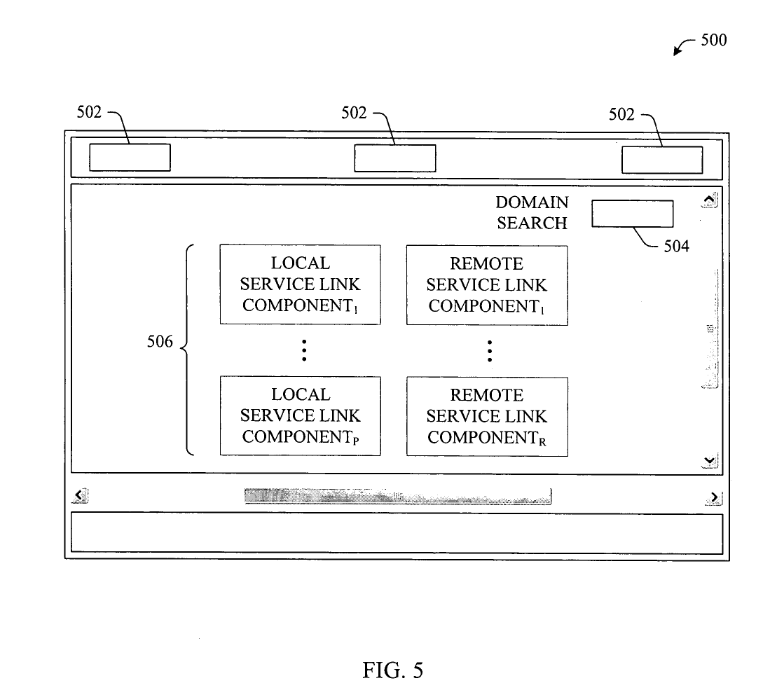

FIG. 5 illustrates an exemplary screen print of a domain or web page 500. It is to be understood and appreciated that a domain can be representative of a web page, website or the like. It is also to be understood that the page and/or site can be associated with the Internet, an intranet, or the like. While certain ways of displaying information to users are shown and described with respect to certain figures as screenshots, those skilled in the relevant art will recognize that various other alternatives can be employed. The terms “screen,” “web page,” “website” and “page” are generally used interchangeably herein. The pages or screens are stored and/or transmitted as display descriptions, as graphical user interfaces, or by other methods of depicting information on a screen (whether personal computer, personal data assistant (PDA), mobile telephone, or other suitable device, for example) where the layout and information or content to be displayed on the page is stored in memory, database, or another storage facility.

As shown, a web page 500 can include any number of search inputs 502. For example, suppose a web page 500 has three general purpose data-entry bars or search inputs 502. In one scenario, one of these data entry bars 502 can be employed for general Internet searches, one for stock quotes and one for local zip code. Additionally, web page 500 can include a domain specific search bar 504 (or data entry input). As described above, this domain specific search bar 504 (e.g., receiving component) can employ algorithmic mechanisms to associate the input to one, or a group of, link component(s) 506.

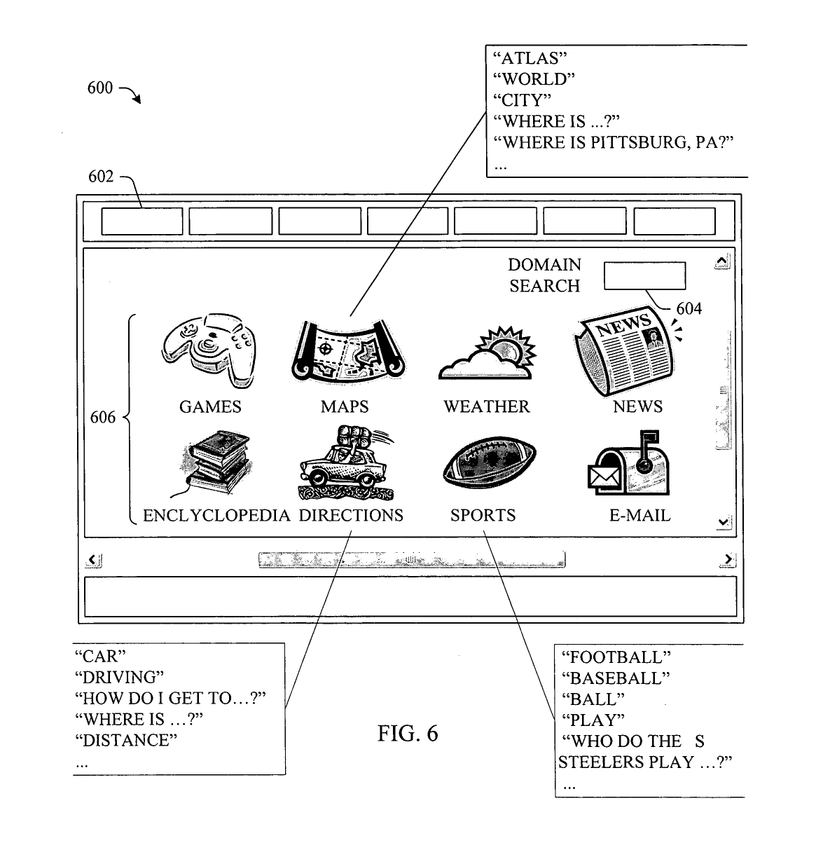

Domain 500 can include 1 to P local service link components, where P is an integer. Additionally, domain 500 can include 1 to R remote service link components, where R is an integer. As described with reference to FIGS. 1 to 4, a user can enter a search criteria into domain search input 504 (e.g., “smart find” input) which can thereafter be employed to access a domain specific link (e.g., 506). Behind the scenes (e.g., transparent to the user), the system can translate, decipher, interpret, etc. and associate the search criteria to one or more appropriate service links 506. Application of the domain search bar 504 can be better understood upon a review of FIG. 6 that follows.

Illustrated in FIG. 6 is an exemplary web page 600. As shown, the web page 600 can include multiple general purpose search bars 602. These general purpose search bars 602 can be employed to search the Internet (or other network) for links that match or are associated to a certain input criteria. As well, these general purpose search bars 602 can sometimes be employed to search more specific criteria such as zip codes, stock quotes, phone numbers, etc.

A domain specific search bar 604 can be used to search links specific to the web page 600. As shown, graphical iconic representations and/or descriptive indicia can be included and representative of domain specific links. These domain specific links are shown in FIG. 6 as links 606. As described above, conventional systems do not enable a user to search (e.g., “control+f”) for these links unless the user knows the specific keyword(s) included within the descriptive indicia.

In addition to conventional searching mechanisms, the subject web page and more particularly, smart find mechanism 604, can be employed to intelligently locate domain specific links 606. As described earlier, conventional searching mechanisms (e.g., “control+f”) require a user to know displayed descriptive words and/or identifiers thereby targeting a search for such terms and/or identifiers. While the subject invention contemplates the conventional searching methods, the “smart find” functionality enables a user to be able to intelligently search for domain specific links (e.g., 606).

With reference again to FIG. 6, these intelligent or “smart find” functionalities will be better understood upon a discussion of the examples illustrated. While FIG. 6 illustrates specific examples of the “smart find” functionality, it is to be understood and appreciated that other examples of looking-up, mapping, interpreting, deciphering, inferring, etc. a search criteria can be effected. These additional examples are to be considered within the scope and as a part of this disclosure and claims appended hereto.

In one example, consider a “MAPS” iconic representation as illustrated. With conventional methods, it would necessary for a user to know that the link is associated with the word “MAPS” in order to locate the link in a conventional find operation (e.g., “control+f”). However, oftentimes, a web page developer does not use such descriptive terms. As well, frequently, terms of art or trade names are used to describe a link. As will be understood, in these situations, it is not particularly easy and/or obvious for a user to select the necessary term upon a search.

In accordance with the subject “smart find” mechanisms, upon searching for “MAPS,” a user can enter any logical and/or descriptive term into the domain search bar 604. By way of example and not limitation, a user can enter the word “ATLAS,” “WORLD,” “CITY,” or the like into search bar 604. Subsequently, the receiving component, interpretation component and mapping component functionality can employ algorithmic methods to associate these inputted terms to the “MAPS” domain specific link. As described, any mechanism can be employed, including, but not limited to, local or remote, tables, dictionaries, metadata, translation, conversion or the like to effect association (e.g., mapping) the input criteria to a domain specific link and/or service. Although the examples described herein are directed to textual input, it is to be understood that alternative aspects exist that employ speech recognition mechanisms by which to enter search criteria. These additional aspects are to be included within the scope of this disclosure and claims appended hereto.

Additionally, the subject “smart find” can employ natural language mechanisms to interpret and/or infer a target domain specific link and/or service from a search input. For instance, in one example, a user can input a question such as “Where is . . . ?” Accordingly, the subject mechanisms can be employed to parse the input string thereby identifying specific words and/or terms to determine an intended target. Continuing with this example, suppose a user enters “Where is . . . ?” into the domain search bar 604. The subject mechanisms can analyze, identify and/or associate this string, based at least in part upon one keyword, to domain specific links such as “MAPS” and to “DIRECTIONS.”

In another example, the subject invention can employ spelling correction thus identifying an intended target domain specific link and/or service. By way of further example, suppose a user inputs “WHERE IS PITTSBURG, PA?” The subject “smart find” mechanisms can employ correction algorithms to change “PITTSBURG” to “PITTSBURGH” thereby establishing an intended link (e.g., MAPS or DIRECTIONS in the example of FIG. 6). Other spelling corrections and/or associations can employed to identify an intended domain specific link or group of links. For instance, the subject “smart find” mechanisms can correct misspelled words such as “ALTAS” to be “ATLAS” thereby returning or accessing the “MAPS” domain specific link.

Other examples are illustrated in FIG. 6 that employ the novel “smart find” mechanisms to effect selection of domain specific links and/or services. As shown, logical associated keywords can be mapped to specific links as well as strings can analyzed to identify keywords and/or identifiers thereafter returning a domain specific link. As shown in one example, entering the phrase “WHO DO THE STEELERS PLAY . . . ?” into domain search box 604 can associate a user to the “SPORTS” domain specific link. In other words, because the system can recognize the word “PLAY” an assumption can be made that the user is in search of either “GAMES” or “SPORTS” in view of the available domain specific links. Further analysis identifies the word “STEELERS” which can be associated to a National Football League team. Thus, the system can infer that the user is in search of the “SPORTS” link.

Additionally, a user can enter the name of a web page service in this “smart find” data entry bar 604. It is to be understood that, since the system has to detect one (or more) of the finite number of possibilities (e.g., 8 in the case of FIG. 6), this data entry bar 604 can be particularly more effective than the conventional “control+f” mechanisms.

By way of further example, entering “games” can indicate that a user would like to click the domain specific link and access the domain specific service, “GAMES.” The subject “smart find” can also access this target link/service by entering “gmaes.” Moreover, entering “gms” or “gm” could also accomplish the same end. As described, entering “play” can also return the target “GAMES” link/service.

All in all, by using the novel “smart find”, when a user is looking to find some service, the user only needs to give a slight hint to the data-entry bar 604. Again, this slight hint is sufficient because the system only has to detect the link/service among a finite number of domain specific links/services. As described, other input mechanisms can include speech recognition and natural language mechanisms. Although many of the aspects described herein are directed to web page aspects, it is to be appreciated that other aspects can exist that enable smart searching upon a web site, group of web sites and/or group of web pages.

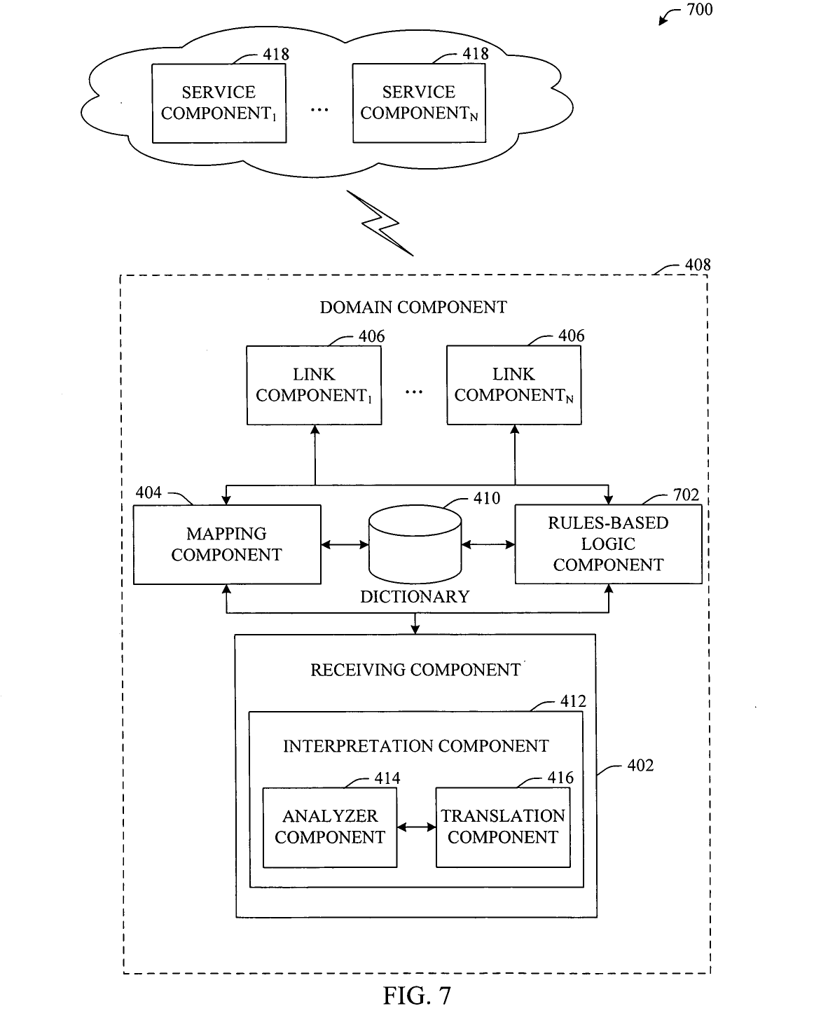

With reference now to FIG. 7, an alternate aspect of search system 700 is shown. More particularly, system 700 can include a rules-based logic component 702 that can facilitate and/or compliment the system described supra. Rules-based logic component 702 can facilitate setting thresholds with regard to the core functionality of the “smart find” mechanisms described above. In one example, a user can select a sensitivity setting with respect to spelling corrective functionality. In another example, a user can proactively associate terms or identifiers with specific links. By way of example with respect to FIG. 6, a user can establish an association that automatically links the word “WHERE” to “DIRECTIONS.” Setting this type of proactive association can limit the resultant domain specific link to “DIRECTIONS” thus bypassing “MAPS.”

In accordance with this alternate aspect, an implementation scheme (e.g., rule) can be applied to define and/or implement a query. It will be appreciated that the rule-based implementation can automatically and/or dynamically define and implement a query of a domain and/or data store. In response thereto, the rule-based implementation can select domain specific component(s) (e.g., link(s), service(s)) included within the result(s) by employing a predefined and/or programmed rule(s) based upon any desired criteria (e.g., link/service type).

By way of further example, a user can establish a rule that can implement a query of domain specific links/services (e.g., music). In this exemplary aspect, the rule can be constructed to select all music links from the present domain and/or webpage. Accordingly, a result set of data components can be obtained and/or accessed as desired. It will be appreciated that any of the specifications utilized in accordance with the subject invention can be programmed into a rule-based implementation scheme.

In the exemplary aspect of FIG. 7, the rules-based component 702 can be programmed or configured in accordance with a user-defined preference. As well, a rule can be established in accordance with a specific hardware configuration or in accordance with a software application. For example, a rule can be constructed in accordance with specific memory capacity and/or display of a device. In other words, a rule can be established to take into consideration the specific limitations of a hardware device (e.g., memory capacity). Thus, in one aspect, if a specific handheld device has low memory capacity, a rule can be generated to ignore and not associate links/services that require a predefined memory threshold.

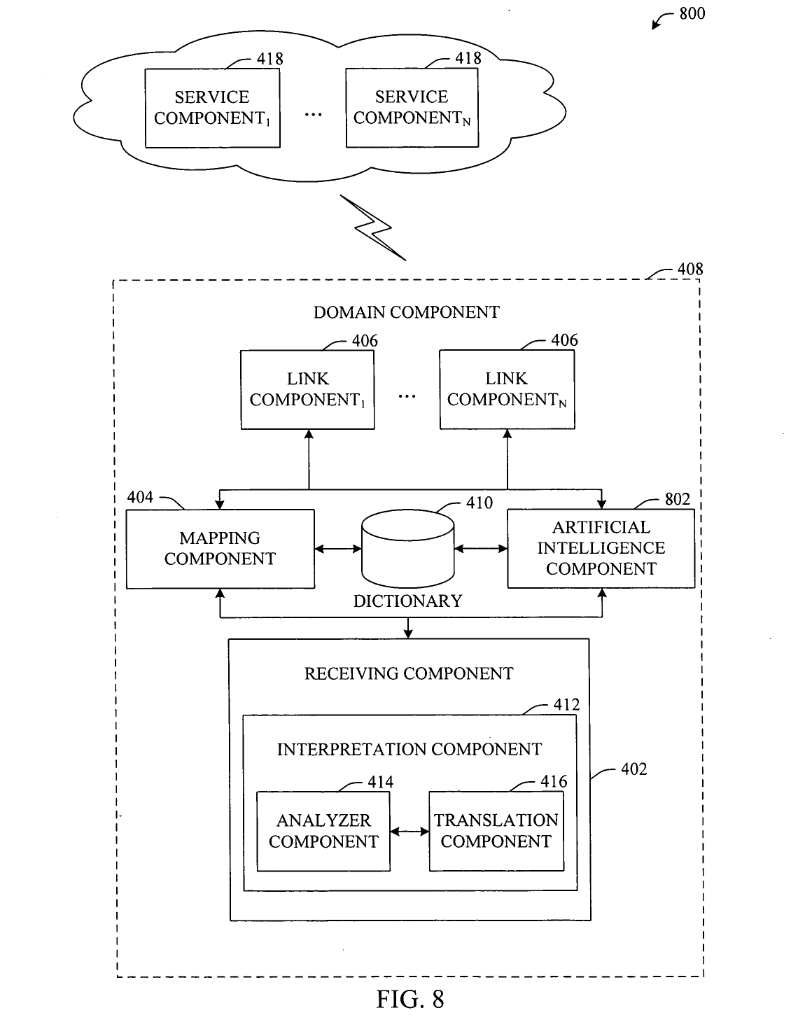

FIG. 8 illustrates a system 900 that employs AI which facilitates automating one or more features in accordance with the subject invention. It is to be appreciated that the AI mechanisms described herein can be employed in addition to or in place of the rules-based mechanisms described above.

The subject invention (e.g., in connection with selection) can employ various AI-based schemes for carrying out various aspects thereof. For example, a process for determining when to associate a domain specific link with respect to a search input can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of “smart find” mechanisms for example, attributes can be words, phrases, identifiers or other data-specific attributes derived from the words, (e.g., titles, presence of key terms), and the classes are categories or areas of interest.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria which domain specific links to render based upon a search criteria, an intended meaning of a search input, etc. The criteria can include, but is not limited to, the type of link/service, the amount of data to be mapped from a search input, the importance of the link/service, and the level of confidence requested for selecting domain specific links/services.

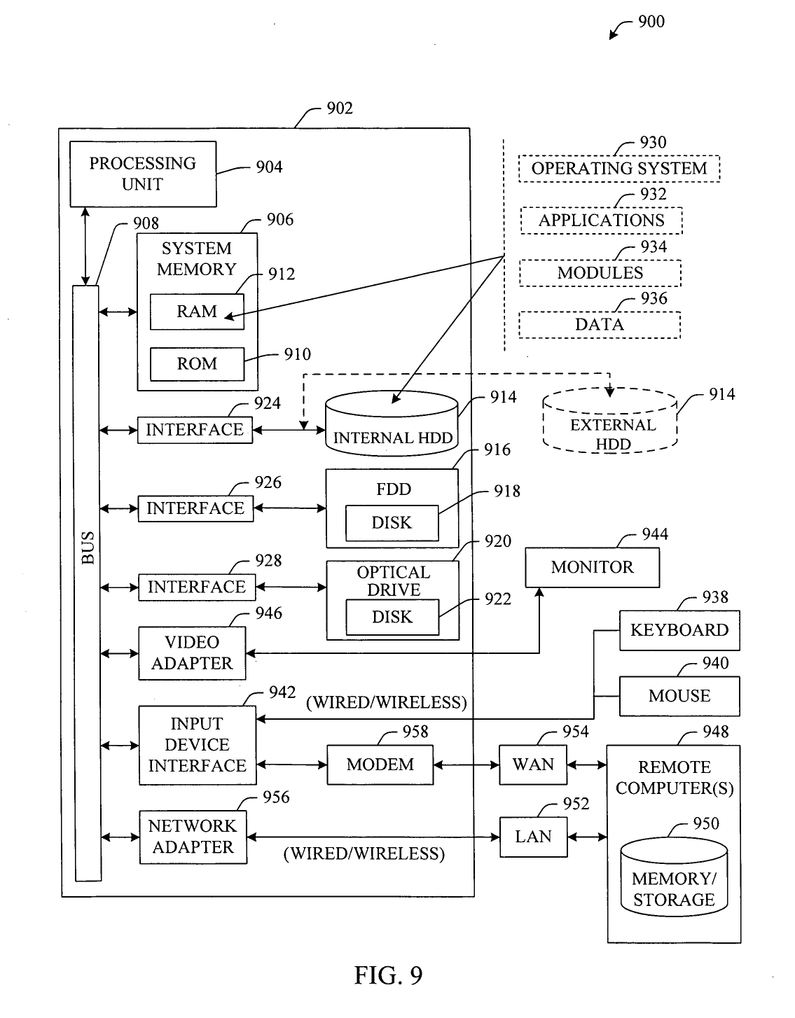

Referring now to FIG. 9, there is illustrated a block diagram of a computer operable to execute the disclosed architecture with respect to a domain specific search or “smart find” operation. In order to provide additional context for various aspects of the subject invention, FIG. 9 and the following discussion are intended to provide a brief, general description of a suitable computing environment 900 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the invention includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject invention.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the invention can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

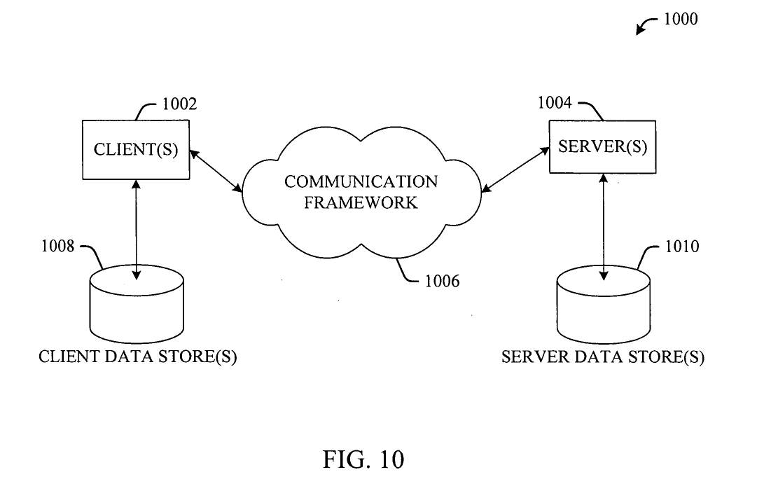

Referring now to FIG. 10, there is illustrated a schematic block diagram of an exemplary computing environment 1000 in accordance with the subject “smart find” mechanisms. The system 1000 includes one or more client(s) 1002. The client(s) 1002 can be hardware and/or software (e.g., threads, processes, computing devices). The client(s) 1002 can house cookie(s) and/or associated contextual information by employing the invention, for example.

The system 1000 also includes one or more server(s) 1004. The server(s) 1004 can also be hardware and/or software (e.g., threads, processes, computing devices). The servers 1004 can house threads to perform transformations by employing the invention, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates a domain dependent find operation, comprising:
a receiving component that receives an input that represents a search request for a domain dependent service, the input includes an alphanumeric string; and
a mapping component that maps the alphanumeric string to a domain specific link that facilitates accessing the domain dependent service.

2. The system of claim 1, the mapping component employs a dictionary that facilitates associating the alphanumeric string to the domain specific link.

3. The system of claim 1, the mapping component maps at least a portion of the alphanumeric string to a hidden alphanumeric string that corresponds to the domain specific link.

4. The system of claim 1, the domain is a web page.

5. The system of claim 1, further comprising an interpretation component that construes the alphanumeric string and communicates a meaning of the alphanumeric string to the mapping component.

6. The system of claim 1, further comprising a translation component that deciphers the alphanumeric string and communicates a meaning of the alphanumeric string to the mapping component.

7. The system of claim 1, the input includes a criterion that describes the webpage dependent service, the criterion includes at least one of a hint, a natural language string, a clue, a criterion, a descriptor, a parameter and an identifier.

8. The system of claim 7, further comprising an interpretation component that construes the criterion and communicates with the mapping component to identify the domain specific link that corresponds to the domain dependent service.

9. The system of claim 1, further comprising an artificial intelligence (AI) component that employs at least one of a probabilistic and a statistical-based analysis to infer an intended target web page dependent service based at least in part upon of the alphanumeric string.

10. The system of claim 1, the input is a spoken input.

11. A method for locating a webpage dependent service, comprising:
receiving a request for the webpage dependent service, the request includes an alphanumeric string; and
mapping at least a portion of the alphanumeric string to an identifier that represents a link that corresponds to the webpage dependent service.

12. The method of claim 11, further comprising interpreting the alphanumeric string and communicating the interpretation to the mapping component.

13. The method of claim 12, the act of interpreting comprises comparing the alphanumeric string to a plurality of hidden strings.

14. The method of claim 12, the act of interpreting comprises deciphering the alphanumeric string to determine an intended meaning of the alphanumeric string.

15. The method of claim 14, further comprising inferring the intended meaning based at least upon a user preference.

16. A system that facilitates employing a webpage dependent service, comprising:
means for receiving a search request;
means for inferring a target domain specific link from the search request; and
means for linking to a service based at least in part upon the inferred target domain specific link.

17. The system of claim 16, further comprising means for deciphering the search request based at least in part upon a plurality of alphanumeric characters in a string that represents the search request.

18. The system of claim 16, further comprising means for inferring the target domain specific link based at least in part upon a user preference.

19. The system of claim 16, the act of interpreting the search request comprises comparing the search request to at least one of a plurality of entries in a dictionary and metadata embedded within a link associated to the service.

20. The system of claim 16, the search request is a spoken input.
